(19) United States
(12) Patent Application Publication
(10) Pub. No.: US 2024/0273764 A1
(43) Pub. Date: Aug. 15, 2024

(54) TEXTURE DATA COMPRESSION WITH RESIDUAL CODING

(71) Applicant: Meta Platforms Technologies, LLC, Menlo Park, CA (US)

(72) Inventors: Cheng Chang, Redmond, WA (US); Xuejing Lei, Los Angeles, CA (US)

(21) Appl. No.: 18/168,111

(22) Filed: Feb. 13, 2023

(51) Int. Cl. G06T 9/00; G06T 7/11; G06T 7/40; G06T 7/90

(52) U.S. Cl. CPC G06T 9/00; G06T 7/11; G06T 7/40; G06T 7/90; G06T 2207/10024; G06T 2207/20021

(57) ABSTRACT

In one embodiment, a computer system may access one or more first texture components and one or more second texture components of a physically-based rendering (PBR) texture set. The computer system may further determine a predicted texture component associated with each of the one or more second texture components based on the one or more first texture components. The computing system may further determine, for each of the one or more second texture components, a residual component, based on a comparison of the predicted texture component and each of the one or more second texture components. The computing system may then encode the PBR texture set based on the one or more first texture components and the residual components.

### TECHNICAL FIELD

This disclosure generally relates to data compression, and, more specifically, to texture data compression with residual coding.

### BACKGROUND

Artificial reality involves the display of computer-generated graphics to a user in an immersive manner. The goal is to cause the user to experience the computer-generated graphics as though they existed in the world before them. Rendering computer-generated graphics for artificial reality is a computationally-intensive task, often requiring expensive and specialized hardware. This is due at least in part to the requirement that the graphics displayed to the user must be very high quality. For a user to believe that the graphics represent, or are a part of, the world around them, the graphics must be believably high quality. The screen-door effect, where either the graphics or the display used to project the graphics allows the user to see lines between pixels can ruin any sense of immersion. Furthermore, graphics for artificial reality scenes are often interactive-when a user “moves” in the virtual space, the space moves with or in response to them. Latency between a user's movement, or movement command, and displaying the effects of that movement can cause great discomfort to the user, such as virtual-reality sickness. Because a user's movements are typically unpredictable, pre-rendering most components of an artificial reality scene is impractical.

### SUMMARY OF PARTICULAR EMBODIMENTS

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Textures may generally include two-dimensional (2D) images that map to a three-dimensional (3D) surface, in which the individual pixels of the texture images may be referred to as “texels” (e.g., texture elements). For example, during graphics rendering, the textures of visible objects are sampled to generate a final image for display. Physically based rendering (PBR) is typical in today's artificial reality (e.g., AR, VR, MR) applications. Developers and artists use high-resolution PBR texture (e.g., albedo, normal, metallic, roughness, ambient occlusion) maps to describe a texture in rendering images to provide users with more realistic and immersive user experiences. PBR textures information is fed to a graphics processing unit (GPU) renderer, and the GPU renderer conducts sophisticated calculations based on the information to decide how light interacts with the surface of a material. The developers may compress a multi-channel texture set by separately encoding each texture channel and storing compressed texture data in GPU memory. However, it may be inefficient to encode each channel independently because there may be strong correlations between the channels. For example, (R)ed, (G)reen, (B)lue values are identical in a grey level image. In another example, when zooming in to a block of an image by PBR, pixel values of the block may contain different shades of the same color. Under both circumstances, saving redundant indices of each texture map in GPU memory may be unnecessary. Therefore, providing techniques to improve efficiency and save GPU memory space in texture data compression may be helpful.

Particular embodiments disclosed herein are directed to texture compression techniques that leverage strong correlation between texture channels in a pixel block. Conventional compression techniques compress a multi-channel texture set in the manner of compressing them separately and storing them separately in the GPU memory. The multi-channel texture set may comprise a plurality of texture components. To allow the multi-channel texture set of a material for PBR rendering to be encoded efficiently using less bits and to save GPU memory space, embodiments of this disclosure provide a method of compressing the multi-channel texture set with cross channel prediction using one subset (e.g., RGB channels) of the multi-channel texture set storing one compressed subset texture map (e.g., compressed RGB image) in the GPU memory.

The present embodiments are directed to techniques for compressing texture components of a material for PBR rendering jointly and providing a residual coding method of encoding textures components based on correlations of each texture component. In some embodiments, a method implemented by a computer system may comprise accessing a plurality of texture components of a material for PBR rendering, the texture components comprise one or more first texture components and one or more second texture components. For example, in one embodiment, an N-bit image (e.g., 32-bit image) may be rendered from texture components to be compressed and stored and/or transmitted. In some embodiments, the one or more first texture components may comprise color components, wherein the color components comprise a red color component, a green color component, and a blue color component. One or more second texture components may comprise one or more of a normal texture, a displacement texture, a secularity texture, a roughness texture, a metallic texture, an ambient occlusion texture, an albedo texture, a transparency texture, and a fuzz texture.

In some embodiments, the system may then determine a predicted texture component associated with each of the one or more second texture components based on the one or more first texture components. In some embodiments, the system may encode the color components into compressed color components, receive a reconstructed base color (RGB) image, from a decoder, based on the compressed color components, and determine the predicted texture component associated with each of the one or more second texture components based on the reconstructed base color (RGB) image. For example, the system may encode the RGB color components and obtain a reconstructed RGB image. The system may then predict, using predictors, a predicted texture component, respectively, for each of the rest texture components (e.g., metallic texture component, roughness texture component, and normal texture component) of the material for PBR rendering. For example, the system may determine a predicted metallic texture component according to the reconstructed RGB image, a roughness texture component according to the reconstructed RGB image; and a normal texture component according to the reconstructed RGB image.

In some embodiments, the system may comprise predictors to perform image processing to the reconstructed RGB image to extract characteristics. In some embodiments, the system may perform image filtering to the reconstructed RGB image, and may then determine the predicted texture component based on the filtered reconstructed RGB image, wherein the image filtering comprises at least one of low pass filtering, high pass filtering, edge detection, thresholding, or contrast enhancement. In some embodiments, the predictors may comprise linear predictors. In some embodiments, the predictors may comprise a recursive least square (RLS) predictor. In some embodiments, the predictors may comprise artificial neural network (ANN) models to determine the predicted texture components. In some embodiments, the system may determine the predicted texture components using one or more predictors and select the optimal encoding method for offline encoding. In some embodiments, the system may determine activations of the predictors based on the characteristic of the reconstructed RGB image.

In some embodiments, the system may divide the reconstructed base color image into pixel regions (e.g., 128×128 block), determine an image characteristic associated with each of the pixel regions, and determine the predicted texture component associated with each of the one or more second texture components based on the image characteristic associated with each of the pixel regions.

In some embodiments, the system may further determine a linear correlation between the one or more first texture components and each of the one or more second texture components, and then determine the predicted texture component associated with each of the one or more second texture components based on each of the linear correlation.

In some embodiments, the system may then determine, for each of the one or more second texture components, a residual component, based on a comparison of the predicted texture component and each of the one or more second texture components. In some embodiments, the system may determine a residual by subtracting the predicted texture component from the original texture component. For example, the system may determine a metallic texture residual by subtracting the predicted metallic texture from the metallic texture of the plurality of texture components of the image.

In some embodiments, the system may then encode the image, based on the one or more first texture components and the residual components. In some embodiments, the one or more first texture components may be the RGB color components. For example, once the system determines the residuals, it may encode the residuals and store the compressed residuals and the compressed base color in a GPU memory for downstream processing (e.g., decoding).

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 2 illustrates an example encoder-decoder (codec) system.

FIG. 3 illustrates an example method of texture data compression with residual coding.

FIG. 4 illustrates an example method of compressing a texture dataset based on channel predictors and a base color map.

FIG. 5 illustrates an example GPU memory for storing compressed texture with residual coding.

FIG. 6A illustrates an example predictor implementation using image filtering of a reconstructed RGB image.

FIG. 6B illustrates an example predictor implementation using a linear predictor of a reconstructed RGB image.

FIG. 6C illustrates an example predictor implementation using a Recursive Least Square (RLS) predictor of a reconstructed RGB image.

FIG. 7 illustrates an example artificial neural network.

FIG. 8 illustrates an example computer system.

### DESCRIPTION OF EXAMPLE EMBODIMENTS

Because artificial reality devices involve creating digital scenes or superposing computer-generated imagery onto a view of the real world, they provide a platform for designers and engineers to provide new forms of information, entertainment, or methods of collaboration. For example, artificial reality devices may allow users to communicate, seemingly in person, over long distances, or assist users by informing them of the environment around them in an unobtrusive manner. Because artificial reality experiences can often be customized, the user's experience with artificial reality may be deeply personal and highly engaging if presented with sufficient clarity and convenience.

One way that artificial reality experiences can augment human ability is with computer-generated images and/or text added to the real world, as in an augmented or mixed reality. From this simple principle, a variety of compelling use cases can be considered. Labels (e.g., texts, glyphs, etc.) or images describing a real-world object may be fixed in the world space (e.g., location-aware labels acting as street signs or providing a live map of a bike path), or images fixed to a real-world object as it moves through the space (e.g., a label added to a bus as it going on its route that provides detailed information about its route or capacity). Labels could also be used to help a user navigate through an unfamiliar city (e.g., creating a waypoint for the nearest restroom), or help find a friend in a crowd (e.g., a socially-aware waypoint fixed to another user). Other experiences worth considering may be based on interactions with real-world objects. For example, a user could “project” video onto a wall or screen that allows for the video to be played and visible to only herself or to others with access to a shared augmented space. As another example, a user could fix computer-generated text to a physical object to act as an augmented-reality book or magazine. Content could be displayed relative to the object (allowing a user to physical asset aside an augmented-reality) or could be displayed in a fixed relation to the user's (e.g., a tutorial video constantly playing in a corner of the view). Presented media could be customized to the user, so that the same content display space could content relevant to each person viewing the same physical space. As another example, a user could interact with computer-generated graphics by “touching” an icon, or “manipulating” the computer-generated images manually. These graphics could be shown to multiple users working on a project, enabling opportunities for team collaboration (e.g., multiple architects working on a three-dimensional digital prototype in a building together in real-time).

To facilitate use, the display that outputs the computer-generated graphics should be intuitive, constantly accessible, and unobtrusive. One approach for displaying high definition artificial reality graphics to a user is based on a head-mounted display. The user wears an apparatus, such as a visor, headset, or glasses, capable of displaying computer graphics display. In augmented or mixed reality experiences, the computer graphics can be seen alongside, or on top of, the physical world. However, rendering these computer graphics is computationally intensive. Therefore, in most cases rendering is performed by powerful computers communicatively attached (e.g., via a cable or wireless communication protocol, such as Bluetooth) to a head-mounted display. In such a configuration, the head-mounted display is limited by bulky cords, bandwidth and power limitations, heat restrictions, and other related constraints. Yet, the limits of these constraints are being pushed. Head-mounted displays that are comfortable and efficient enough for day-long wearing, yet powerful enough to display sophisticated graphics are currently being developed.

One technique used to reduce actual display size without impacting apparent display size is known as a scanning display. In a scanning display, multiple smaller images are combined to form a larger composite image. The scanning display uses source light, one or more scanning elements comprising reflectors, and an optics system to generate and output image light. The output image light may be output to the eye of the user. The source light may be provided by emitters, such as light-emitting diodes (LEDs). For example, the light source may be an array of 2560×1440 LEDs. The reflectors may be any suitable reflective surface attached to the scanning element. In particular embodiments, the scanning element may be a scanning mirror driven using one or more microelectromechanical systems (MEMS) components. The optics system may comprise lenses used to focus, redirect, and otherwise augment the light. The scanning element may cause the source light, treated by light guiding components, to be output to the eye of the user in a specific pattern corresponding to a generation pattern used by the emitters to optimize display draw rate. Because, for example, all emitters need not be active at once, and in addition to a variety of other factors, scanning displays may require less power to run, and may generate less heat, than traditional display comprised of the same emitters. They may have less weight as well, owing in part to the quality of the materials used in the scanning element and optics system. One consequence of using a scanning display is that in exchange for, e.g., power, weight, and heat efficiency, a scanning displays may not perfectly display images as presented to them, e.g., images intended for traditional displays. There may be non-uniform distortions such as geometric warping of images and distortion of colors and specifically brightness. As is explained further herein, these distortions can be corrected by post-processing graphics to-be displayed to counteract the distortion before they are passed to the display, creating the effect that there is no distortion. Although this disclosure describes displays in a particular manner, this disclosure contemplates any suitable displays.

Since its existence, artificial reality (e.g., AR, VR, MR) technology has been plagued with the problem of latency in rendering AR/VR/MR objects in response to sudden changes in a user's perspective of an AR/VR/MR scene. To create an immersive environment, users may need to be able to move their heads around when viewing a scene and the environment may need to respond immediately by adjusting the view presented to the user. Each head movement may slightly change the user's perspective of the scene. These head movements may be small but sporadic and difficult, if not impossible, to predict. A problem to be solved is that the head movements may occur quickly, requiring that the view of the scene be modified rapidly to account for changes in perspective that occur with the head movements. If this is not done rapidly enough, the resulting latency may cause a user to experience a sensory dissonance that can lead to virtual reality sickness or discomfort, or at the very least, a disruption to the immersive nature of the experience. Re-rendering a view in its entirety to account for these changes in perspective may be resource intensive, and it may only be possible to do so at a relatively low frame rate (e.g., 60 Hz, or once every 1/60th of a second). As a result, it may not be feasible to modify the scene by re-rendering the entire scene to account for changes in perspective at a pace that is rapid enough (e.g., 200 Hz, once every 1/200th of a second) to prevent the user from perceiving latency and to thereby avoid or sufficiently reduce sensory dissonance. One solution involves generating a two-dimensional (2D) image of an object's texture from a particular view of the object, which maps to a three-dimensional (3D) “surface” of the object within the scene. A surface, or texture image, is comprised of object primitives that represent a particular view of the object. A surface corresponds to one or more objects that are expected to move/translate, skew, scale, distort, or otherwise change in appearance together, as one unit, as a result of a change in perspective. Instead of re-rendering the entire view, a computing system may simply resample these surfaces from the changed perspective to approximate how a corresponding object would look from the changed perspective. This method may significantly reduce the rendering processing and thus ensure that the view is updated quickly enough to sufficiently reduce latency. Resampling surfaces, unlike re-rendering entire views, may be efficient enough that it can be used to modify views within the allotted time—e.g., in 1/200th of a second—with the relatively limited processing power of a computing system of a HMD. It may not be feasible for a system that is physically separate from the HMD (e.g., a separate laptop or wearable device) to perform the resampling process because the time scales involved in the resampling process are extremely small. For example, if the resampling process were to be performed in a physically separate system, the HMD would have to transmit information about the current position and orientation of the HMD, wait for the separate system to render the new view, and then receive the new view from the separate system. The present embodiments, to further speed up the overall rendering process, specifically the resampling process, provide compression techniques for compressing texture components of a material for PBR rendering jointly and providing a residual coding method of encoding textures components based on correlations of each texture component.

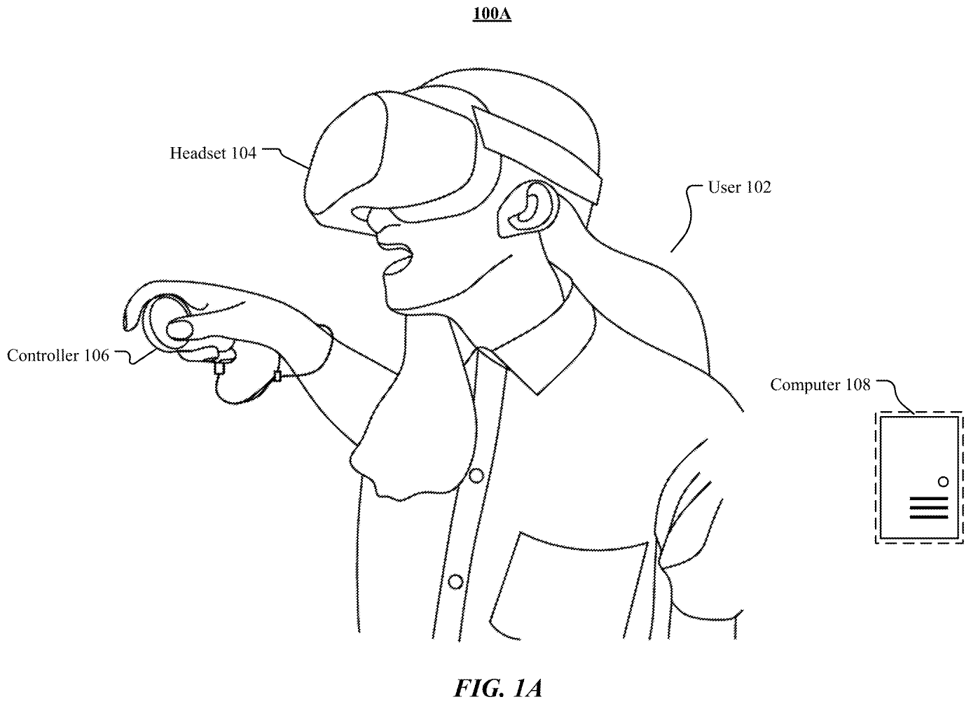

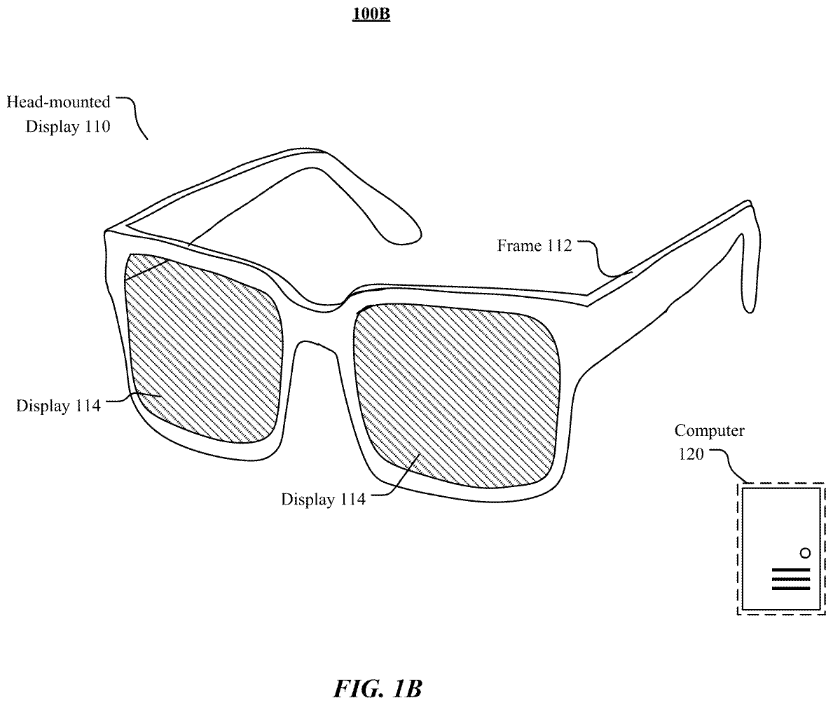

FIG. 1A illustrates an example artificial reality system 100A. In particular embodiments, the artificial reality system 100A may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may be referred as a head-mounted display (HDM). The controller 106 may comprise a trackpad and one or more buttons. The controller 106 may receive inputs from the user 102 and relay the inputs to the computing system 108. The controller 206 may also provide haptic feedback to the user 102. The computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

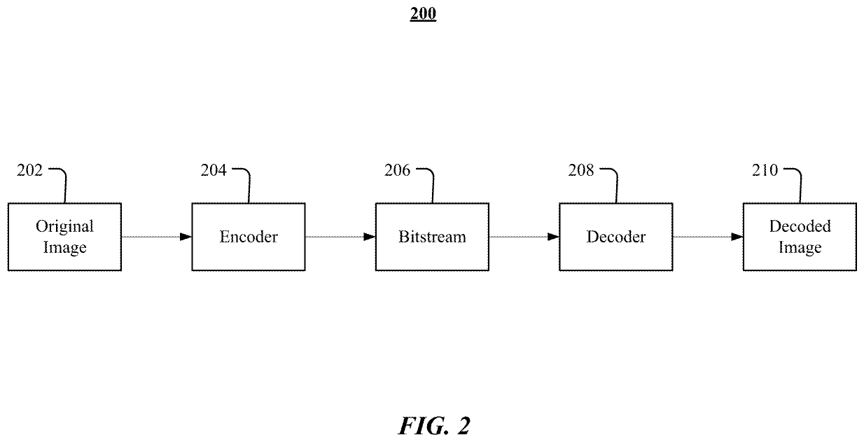

FIG. 2 illustrates an encoder-decoder (codec) system 200 that may be useful in performing forgoing techniques as discussed herein, in accordance with the presently disclosed embodiments. In some embodiments, the codec system 200 may be implemented as part of a subsystem on one or more general purpose processors, or may include a standalone graphic processing units (GPU), an application-specific integrated circuit (ASIC), a system-on-chip (SoC), a microcontroller, a field-programmable gate array (FPGA), or any other processing device(s) that may be suitable for processing image data. As depicted in FIG. 2, in some embodiments, the data flow of the codec system 200 may include receiving an original image 202 to be encoded via an encoder device 204, stored into a bitstream 206, and decoded via a decoder device 208 to generate a compressed and decoded image 210 to be stored and/or transmitted.

In one embodiment, the original image 202 may include one or more 8-bit color images (e.g., still image frames, video image frames) including, for example. In other embodiments, the original image 202 may include a 2-bit color image, a 4-bit color image, a 6-bit color image, a 10-bit color image, a 12-bit color image, a 16-bit color image, a 24-bit color image, or any suitable N-bit color image that may be received and processed by the codec system 200. In certain embodiments, the encoder device 204 may include any device that may be utilized, for example, to receive the original image 202 and convert the original image 202 into a bitstream 206 (e.g., binary pixel data). Similarly, the decoder device 208 may include any device that may be utilized, for example, to receive the encoded bitstream 206 of binary pixel data and decode the bitstream 206 (e.g., binary pixel data) to generate the compressed and decoded image 210.

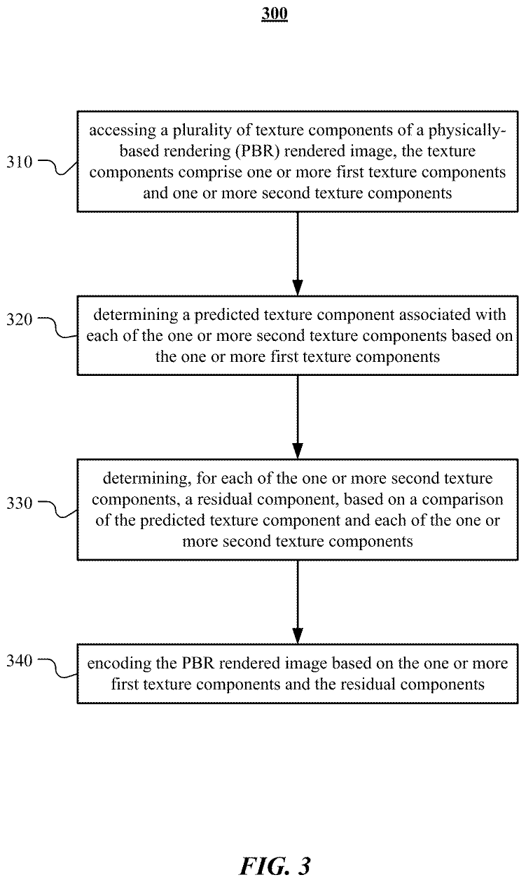

Indeed, as will be further appreciated with respect to FIGS. 3-5 and 6A-6C, the codec system 200, and particularly the decoder device 208, may be utilized for (1) accessing a plurality of texture components of a material for physically-based rendering (PBR), the texture components comprise one or more first texture components and one or more second texture component; (2) determining a predicted texture component associated with each of the one or more second texture components based on the one or more first texture components; and (3) determining, for each of the one or more second texture components, a residual component, based on a comparison of the predicted texture component and each of the one or more second texture components, among various other techniques in accordance with the presently disclosed embodiments.

FIG. 3 illustrates an example method of texture data compression with residual coding. The method may begin at step 310 by accessing a plurality of texture components of a physically-based rendering (PBR) texture set, the texture components may comprise one or more first texture components and one or more second texture components. For example, the one or more first texture components may comprise a base color map that include RGB values of each pixel or pixel block of the image. At step 320, the method may continue by determining a predicted texture component associated with each of the one or more second texture components based on the one or more first texture components. The predicted texture component associated with each of the one or more second texture components based on a reconstructed image of compressed first texture components. At step 330, the method may continue by determining, for each of the one or more second texture components, a residual component, based on a comparison of the predicted texture component and each of the one or more second texture components. At step 330, the method may continue by encoding the PBR texture set based on the one or more first texture components and the residual components. In some embodiments, the method may encode the one or more first texture components into compressed first texture components. The method may then receive reconstructed first texture components, from a decoder, based on the compressed first texture components. The method may then determine the predicted texture component associated with each of the one or more second texture components based on the reconstructed first texture components. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for texture data compression with residual coding, this disclosure contemplates any suitable method for texture data compression with residual coding including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

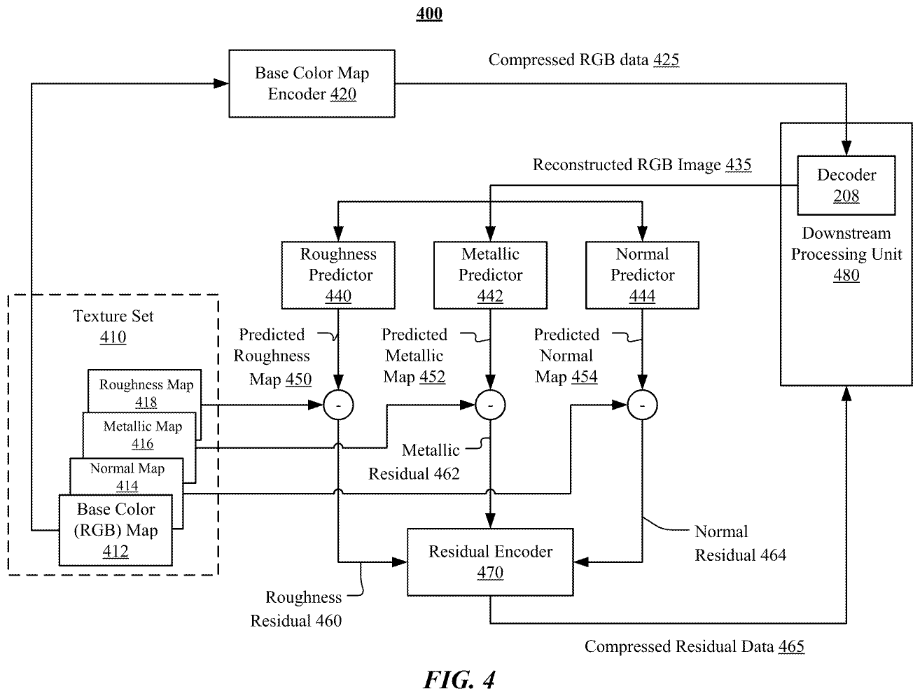

FIG. 4 illustrates an example method of compressing a texture dataset based on channel predictors and a base color map. The encoder 204 may access a texture set 410 including a plurality of texture components of a physically-based rendering (PBR) texture set. The texture set 410 may comprise a base color map 412. The base color map 412 may comprise RGB values of each pixel or pixel block (e.g., 8*8 pixel block) of the PBR texture set. As an example, and not by way of limitation, the texture set 410 may comprise other texture maps such as a normal map 414, a metallic map 416, and a roughness map 418 other than the base color map 412. Alternatively or additionally, the additional texture maps may comprise one or more of one or more of a normal texture map, a displacement texture map, a secularity texture map, a roughness texture map, a metallic texture map, an ambient occlusion texture map, an albedo texture map, a transparency texture map, and a fuzz texture map. The encoder 204 may encode the base color map 415 using a base color encoder 420 into compressed RGB data 425. The base color encoder 420 may encode the RGB channels of the base color map 415 independently. Alternatively or additionally, base color encoder 420 may leverage a strong correlation between the RGB channels of the base color map 412 and encode the RGB channels of the base color map 412 jointly in a similar manner as described in U.S. patent application Ser. No. 17/126,440. The compressed RGB data 425 may be stored in a GPU of the codec system 200. The decoder 208 of the codec system 200 may decode the compressed RGB data 425 into a reconstructed RGB image 435. The encoder 204 may comprise one or more predictors to predict textures associated with the other texture maps in the texture set 410 except for the base color map 415. For example, an RGB image may be used to distinguish organic parts and metal parts. The codec system 200 may leverage the correlations between each texture component of the texture set 410 to encode the PBR texture set using less bits through cross channel predictions. As an example, and not by way of limitation, the encoder 204 may comprise a roughness predictor 440, a metallic predictor 442, and a normal predictor 444 associated with the roughness map 418, the metallic map 416, and the normal map 414, respectively. The encoder 204 may determine a predicted roughness map 450 based on the reconstructed RGB image 435 through the roughness predictor 440. In similar manners, the encoder 204 may determine a predicted metallic map 452 and a predicted normal map 454 respectively. As an example, and not by way of limitation, implementation of the one or more predictors may comprise performing image filtering to capture image characteristics (e.g., edges, an image contrast, an image brightness), determining a linear correlation between the reconstructed RGB image 435 and the predicted maps (e.g., 450, 452, and 454), or employing a Recursive Least Square (RLS) algorithm. The one or more predictors may be implemented identically to each other. Alternatively or additionally, the one or more predictors may be implemented differently. The predicted textures maps may not be accurate compared to the original texture maps in the texture set 410. The encoder 204 may determine a residual component and may subtract the residual map from the original map to improve the accuracy of the cross-channel predictions. The encoder 204 may determine a roughness residual 460 based on a comparison of the original roughness map 418 and the predicted roughness map 450. A metallic residual 462, and a normal residual 464 may be determined similarly. A residual encoder 470 may encode the roughness residual 460, the metallic residual 462, and the normal residual 464, into a compressed residual data 465. The encoder 204 may be configured for both base color encoder 420 and the residual encoder 450. In some embodiments, the residual encoder 470 encodes each residual independently or may leverage a correlation between the residuals and encode the residuals jointly. The encoder 204 may then transmit the compressed residual data 465 and the compressed RGB data 425 to a downstream processing unit for further processing.

Conventional compression techniques compress multi-channel texture sets by compressing each channel map separately and storing the compressed data of each channel separately in the GPU memory. The multi-channel texture set may sometimes be divided into two or more subsets. Within each subset, one channel map may be packed with other channel maps to form a multi-channel image. For example, the multi-channel image may include RGB and alpha image data. Another type of multi-channel image may include Roughness, Metallic, and Ambient occlusion (RMA). Additional texture maps need to be compressed as a separated texture set. At decoding/rendering time, the renderer (e.g., HMD 104) may require a pixel block at a particular location of the image to be rendered, and the decoder may retrieve the corresponding compressed blocks from each separated subset from the GPU memory. The GPU may store the compressed data in a texture cache. In the future, the GPU/renderer will not need to decode each of the compressed texture subsets when it requires pixel blocks from the same location as stored in the texture cache. The disadvantage of the conventional compression techniques is that the decoder has to retrieve the same block from multiple compressed texture subsets and decode them separately and feed to the renderer, where the multiple compressed texture subsets may comprise redundant image data that takes extra GPU memory and slows down the rendering process.

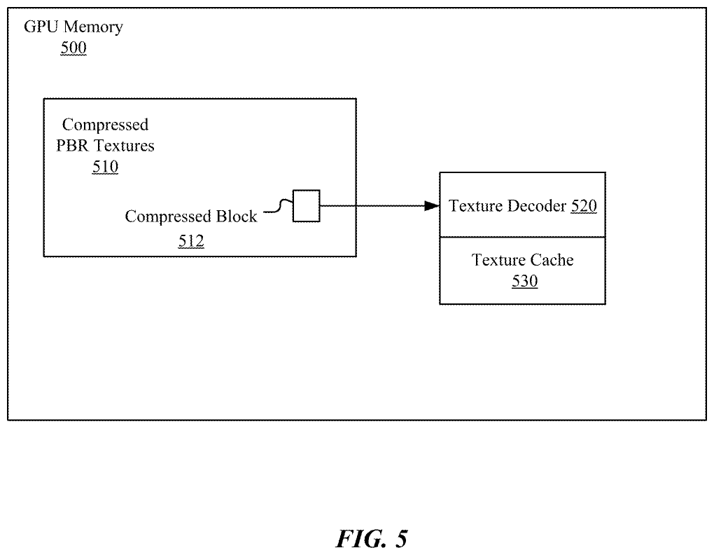

FIG. 5 illustrates an example GPU memory 500 for storing compressed textures with residual coding. The present embodiments are directed to the residual coding method of encoding texture components based on correlations of base color map 412 and the other texture maps within the texture set 410. The PBR textures set may comprise a plurality of pixel blocks. The texture set 410 may be compressed into compressed PBR textures 510 that may comprise compressed RGB data 425 and the compressed residual data 465 on a block-by-block basis. At decoding/rendering time, the renderer (e.g., HMD 104) may require a pixel block at a particular location of the image to be rendered, the decoder may retrieve the corresponding compressed block 512 from compressed PBR textures 510 and feed to a texture decoder 520 and store in a texture cache 530 for future use.

Predictions may be used to compress randomly distributed signals. For example, suppose a portion of the texture maps within an image may be predicted properly when encoding the image. In that case, the encoder may not need to encode the portion of the texture maps that can be predicted, but encode the residuals instead. The residual distribution is easier to compress than each texture set's original signal distribution. From information theory, the Shannon Entropy of the residual distribution may be much smaller than the original distribution and cost fewer bits to encode.

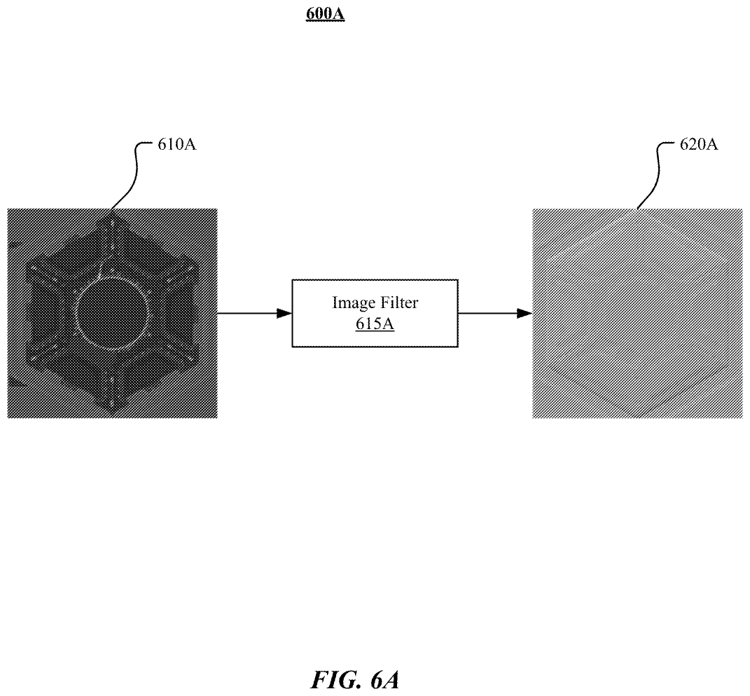

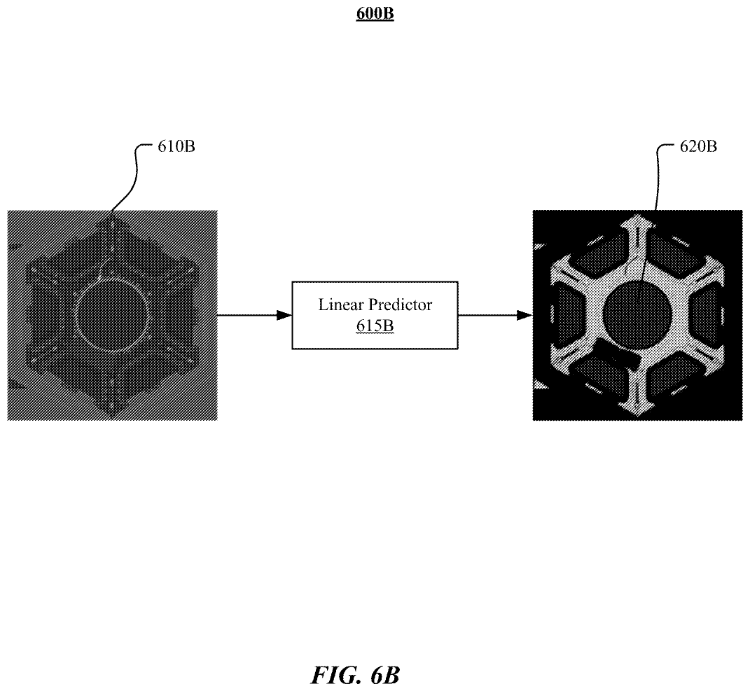

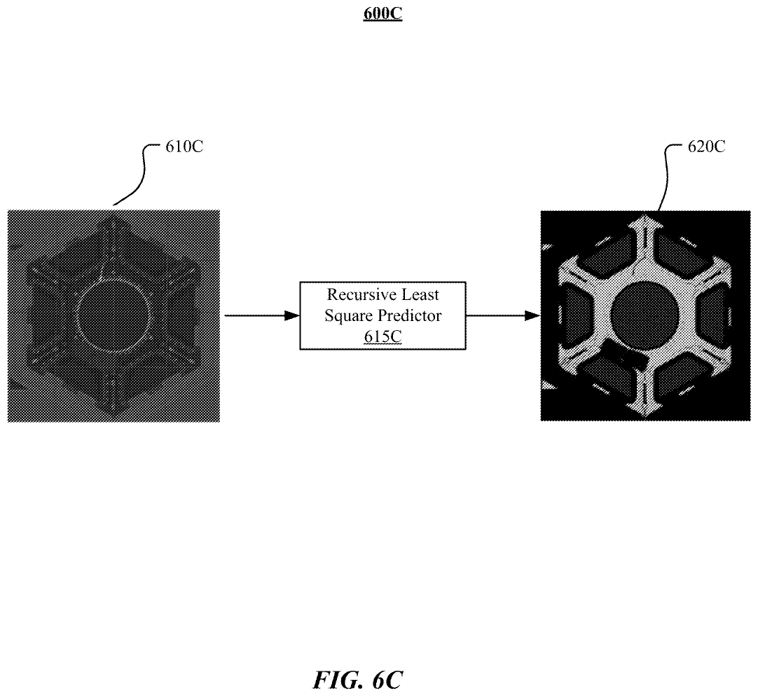

FIG. 6A illustrates an example predictor implementation using image filtering of a reconstructed RGB image. Sometimes the game developer/artist may utilize an RGB image to create texture maps with no ground truth. For example, the game developer may process an original RGB image (e.g., rustic metal image) with image filtering operations to generate texture maps. The texture maps such as a normal texture map may be obtained by applying edge detection and contrast enhancement to the original RGB image. The game developers will feed the texture maps created with image processing tools into a renderer to determine final image texture rendering qualities. The compressed original RGB image and image filtering operations that include indices for each RGB image's pixel block that are used to create the textures may be stored in a compression history. Similarly, to emulate the texture creation process in the texture data compression predictions, the codec system 200 may recall the image filtering operations in the compression history and reproduce the image filtering operations with the stored indices on the decoder side, such that the predicted texture map may be produced directly from the base color image. The GPU will decode any compressed data on block level at rendering time. Therefore, the image filtering operations may be performed on a block level. Alternatively or additionally, the codec system 200 may determine a reconstructed RGB image 610A that comprises reconstructed RGB data 325 from the decoder side. The codec system 200 may then perform image filtering 615A to predict one or more texture components 620A. The image filtering techniques may comprise one or more of low pass filtering, high pass filtering, edge detection, thresholding, or contrast enhancement. As an example and not by way of limitation, each of the texture predictors (e.g., roughness predictor 440, metallic predictor 442, and normal predictor 444) may be implemented using one or more image filtering techniques. Indices to be provided to the predictors may comprise parameters such as kernel sizes, kernel parameters, threshold values, etc. A renderer (e.g., HMD) may request to access each individual pixel block of the image to be rendered. Based on the different characteristics of each pixel block of the image to be rendered, the predictors may comprise different combinations of image filtering operations and/or different parameters for each pixel block.

FIG. 6B illustrates an example predictor implementation using a linear predictor of a reconstructed RGB image. The RGB image 610B may comprise reconstructed RGB image data 435 as an input x=[r,g,b]^{T} of a linear predictor 615B. The linear predictor 615B may provide an output y that indicates the texture 620B to be predicted. The output y may be calculated based on the reconstructed RGB image data x and a linear coefficient w, that is y=x^{T}w, w=[wᵣ, w_{g}, w_{b}]^{T}. The values of wᵣ, w_{g}, and w_{b} may be determined based on a least-square estimation at the encoder when receiving the texture set that include the RGB maps and other texture maps in the PBR texture set. The encoder may perform the least square estimation on a texture level when the correlation between the outputted predicted texture and inputted reconstructed RGB image is consistent across the pixel blocks of the whole image. The encoder may then determine one set of coefficient w. Alternatively or additionally, the encoder may perform the least square estimation on a pixel block level, such that the encode may determine a plurality of sets of coefficients for each block. As implemented on the decoder side, the predictor may receive the compressed image data including compressed RGB data and comprised residual data with one or more sets of coefficients according to the linear prediction for further PRB image rendering or other downstream processing.

FIG. 6C illustrates an example predictor implementation using a Recursive Least Square (RLS) predictor of a reconstructed RGB image. RLS predictor is a more practical approach and may consider a more realistic situation in predicting on a block basis. Although the linear predictor can make block basis prediction, it is costly to save the coefficient for each block. However, using the RLS predictor does not need to store the predictor coefficient. The predictor coefficient may be calculated and updated while decoding an image. RLS may be less costly with a better performance. The RGB image 610C may comprise reconstructed RGB image data 435 as an input x=[r,g,b]^{T} of a Recursive Least Square (RLS) predictor 615C. The RLS predictor 615B may provide an output y that indicates the texture 620C to be predicted. The codec system 200 may perform the RLS prediction on a pixel block level. The prediction process may start with assigning each block with all zero efficient w(0)=[0,0,0]^{T} at time t=0. For the current pixel block, the encoder may calculate the prediction value associated with the pixel f(t)=x(t)^{T}w(t−1), and then calculate a prediction error e(t)=y(t)−ŷ(t). The decoder may read the prediction error e(t) from the compressed texture data at time t. The codec system may then update the inverse correlation matrix:

$$C ( t ) = \frac{1}{δ} [ C ( t - 1 ) - \frac{C ( t - 1 ) {x ( t )}^{T} C ( t - 1 )}{δ + {x ( t )}^{T} ( t - 1 ) x ( t )} ]$$

(forgetting factor δ=0.1), and calculating the gain vector g(t)=C(t)x(t). The codec system may then update the prediction coefficient w(t)=w(t−1)+e(t)g(t) and may continue to perform another iteration for t=t+1 of the next pixel block. In some embodiments, the encoder may divide RGB image 610C into a plurality of regions (e.g., 128*128 pixel block). Each region may be initialized with different weight coefficient instead of zeros to allow a faster convergence of the RLS predictor and better results.

In some embodiments, the encoder may apply the RLS predictor adaptively based on block characteristics. For example, the encoder may turn off RLS predictor when a block has a solid color. For example, the encoder may combine conventional encoding techniques and the texture data compression with residual coding method when certain blocks can be easily encoded without using the cross-channel predictions. For example, the encoder may disable all the predictors when the RGB image lacks information (e.g., too smooth or too solid in color).

In some embodiments, the predictor implementation may comprise non-linear prediction models such as an artificial neural network (ANN). The ANN may be trained at the encoder to determine multiple other texture maps of the texture set based on a selected one or more texture maps (e.g., a base color map).

In some embodiments, multiple prediction implementations may be saved to the encoder, when fed with a texture set, the encoder may be able to perform all the possible predictions based on different implementations of the predictors for each texture to be predicted and decide a particular implementation will be exploited for the predictor and store the certain implementation method in a header of an image frame, so that the decoder may adopt the particular implementation to predict the particular texture map of the image. Decisions are made on the encoder side and may not be transparent to users.

Although this disclosure describes and illustrates particular implementations of the predictor for predicting texture maps based on the reconstructed RGB image, this disclosure contemplates any suitable implementations of the one or more predictors of the codec system 200.

The encoder may analyze and determine the most efficient way to predict a texture offline, such that the texture data compression may take place during the process of the developer/artist prepare the asset and pack into an application (e.g., game) package. Once the texture data is compressed, the texture data stays compressed until used for rendering at an end user device. Physically based rendering texture set may be prepared offline and only loaded to GPU when a user runs application (e.g., plays the game) with synchronous decoding at the renderer of an end user device (e.g., HMD). Since the texture map's prediction analysis and determination may be performed offline at the encoder side, storing the compressed PBR textures in compressed RGB and residual data may reduce GPU memory footprint and save extra memory space such that more textures may be loaded in GPU. Additionally, the method of texture data compression with residual coding may reduce the decoding cost in memory bandwidth other than GPU memory footprint savings. When the compressed textures occupy reduced space in the GPU memory, the saved space will translate to reduced memory bandwidth consumption on GPU at runtime of the application that requires a high-speed frame rate (e.g., 60/90 fps).

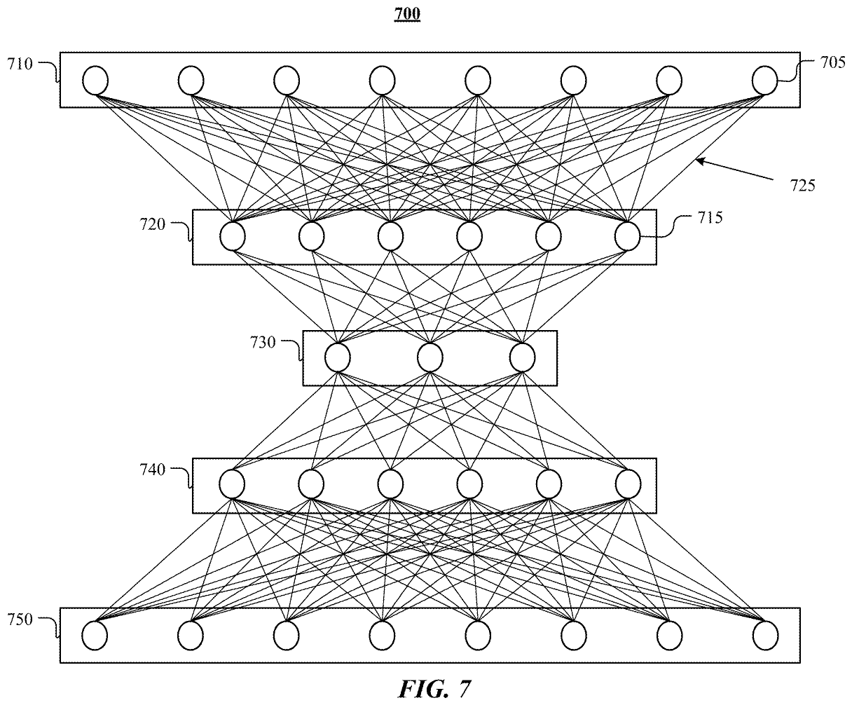

FIG. 7 illustrates an example artificial neural network (“ANN”) 700. In particular embodiments, an ANN may refer to a computational model comprising one or more nodes. Example ANN 700 may comprise an input layer 710, hidden layers 720, 730, 740, and an output layer 750. Each layer of the ANN 700 may comprise one or more nodes, such as a node 705 or a node 715. In particular embodiments, each node of an ANN may be connected to another node of the ANN. As an example and not by way of limitation, each node of the input layer 710 may be connected to one of more nodes of the hidden layer 720. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 7 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 7 depicts a connection between each node of the input layer 710 and each node of the hidden layer 720, one or more nodes of the input layer 710 may not be connected to one or more nodes of the hidden layer 720.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 720 may comprise the output of one or more nodes of the input layer 710. As another example and not by way of limitation, the input to each node of the output layer 750 may comprise the output of one or more nodes of the hidden layer 740. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{{s}_{k}}}{{e}^{{s}_{k}} + {e}^{- {s}_{k}}} ,$$

the rectifier Fₖ(sₖ)=max(0,sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 725 between the node 705 and the node 715 may have a weighting coefficient of 0.4, which may indicate that 0.4 multiplied by the output of the node 705 is used as an input to the node 715. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 700 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

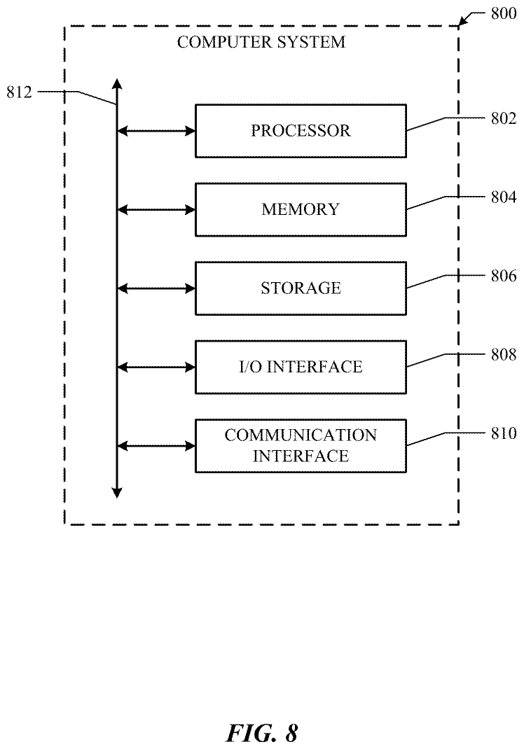

FIG. 8 illustrates an example computer system 800 that may be useful in performing one or more of the foregoing techniques as presently disclosed herein. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein.

As an example, and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate. In certain embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In certain embodiments, processor 802 includes hardware for executing instructions, such as those making up a computer program. As an example, and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example, and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802.

Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In certain embodiments, memory 804 includes main memory for storing instructions for processor 802 to execute or data for processor 802 to operate on. As an example, and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere).

One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example, and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In certain embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In certain embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In certain embodiments, communication interface 810 includes hardware, software, or both providing one or more interfaces for communication (such as, for example, packet-based communication) between computer system 800 and one or more other computer systems 800 or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it.

As an example, and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In certain embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method implemented by a computing system, the method comprising:
accessing a plurality of texture components of a physically-based rendering (PBR) texture set, the texture components comprise one or more first texture components and one or more second texture components;
determining a predicted texture component associated with each of the one or more second texture components based on the one or more first texture components;
determining, for each of the one or more second texture components, a residual component, based on a comparison of the predicted texture component and each of the one or more second texture components; and
encoding the PBR texture set based on the one or more first texture components and the residual components.

2. The method of claim 1, wherein the one or more first texture components comprise color components, wherein the color components comprise a red color component, a green color component, and a blue color component.

3. The method of claim 2, further comprising:
encoding the color components into compressed color components;
obtaining a reconstructed base color image, from a decoder, based on the compressed color components; and
determining the predicted texture component associated with each of the one or more second texture components based on the reconstructed base color image.

4. The method of claim 3, further comprising:
dividing the reconstructed base color image into pixel regions;
determining an image characteristic associated with each of the pixel regions; and
determining the predicted texture component associated with each of the one or more second texture components based on the image characteristic associated with each of the pixel regions.

5. The method of claim 3, further comprising:
performing image filtering to the reconstructed base color image; and
determining the predicted texture component based on the filtered reconstructed base color image,
wherein the image filtering comprises at least one of low pass filtering, high pass filtering, edge detection, thresholding, or contrast enhancement.

6. The method of claim 1, wherein the one or more second texture components comprise one or more of a normal texture, a displacement texture, a secularity texture, a roughness texture, a metallic texture, an ambient occlusion texture, an albedo texture, a transparency texture, and a fuzz texture.

7. The method of claim 1, further comprising:
determining a linear correlation between the one or more first texture components and each of the one or more second texture components; and
determining the predicted texture component associated with each of the one or more second texture components based on each of the linear correlation.

8. A system comprising:
one or more non-transitory computer-readable storage media including instructions; and
one or more processors coupled to the storage media, the one or more processors configured to execute the instructions to:
access a plurality of texture components of a physically-based rendering (PBR) texture set, the texture components comprise one or more first texture components and one or more second texture components;
determine a predicted texture component associated with each of the one or more second texture components based on the one or more first texture components;
determine, for each of the one or more second texture components, a residual component, based on a comparison of the predicted texture component and each of the one or more second texture components; and
encode the PBR texture set based on the one or more first texture components and the residual components.

9. The system of claim 8, wherein the one or more first texture components comprise color components, wherein the color components comprise a red color component, a green color component, and a blue color component.

10. The system of claim 8, wherein one or more processors are further configured to execute the instructions to:
encode the color components into compressed color components;
obtain a reconstructed base color image, from a decoder, based on the compressed color components; and
determine the predicted texture component associated with each of the one or more second texture components based on the reconstructed base color image.

11. The system of claim 8, wherein one or more processors are further configured to execute the instructions to:
divide the reconstructed base color image into pixel regions;
determine an image characteristic associated with each of the pixel regions; and
determine the predicted texture component associated with each of the one or more second texture components based on the image characteristic associated with each of the pixel regions.

12. The system of claim 8, wherein one or more processors are further configured to execute the instructions to:
perform image filtering to the reconstructed base color image; and
determine the predicted texture component based on the filtered reconstructed base color image,
wherein the image filtering comprises at least one of low pass filtering, high pass filtering, edge detection, thresholding, or contrast enhancement.

13. The system of claim 8, wherein the one or more second texture components comprise one or more of a normal texture, a displacement texture, a secularity texture, a roughness texture, a metallic texture, an ambient occlusion texture, an albedo texture, a transparency texture, and a fuzz texture.

14. The system of claim 8, wherein one or more processors are further configured to execute the instructions to:
determine a linear correlation between the one or more first texture components and each of the one or more second texture components; and
determine the predicted texture component associated with each of the one or more second texture components based on each of the linear correlation.

15. A non-transitory computer-readable medium comprising instructions that, when executed by one or more processors of a computing system, cause the one or more processors to:
access a plurality of texture components of a physically-based rendering (PBR) texture set, the texture components comprise one or more first texture components and one or more second texture components;
determine a predicted texture component associated with each of the one or more second texture components based on the one or more first texture components;
determine, for each of the one or more second texture components, a residual component, based on a comparison of the predicted texture component and each of the one or more second texture components; and
encode the PBR texture set based on the one or more first texture components and the residual components.

16. The non-transitory computer-readable medium of claim 15, wherein the one or more first texture components comprise color components, wherein the color components comprise a red color component, a green color component, and a blue color component.

17. The non-transitory computer-readable medium of claim 15, wherein the instructions further cause the one or more processors to:
encode the color components into compressed color components;
obtain a reconstructed base color image, from a decoder, based on the compressed color components; and
determine the predicted texture component associated with each of the one or more second texture components based on the reconstructed base color image.

18. The non-transitory computer-readable medium of claim 15, wherein the instructions further cause the one or more processors to:
divide the reconstructed base color image into pixel regions;
determine an image characteristic associated with each of the pixel regions; and
determine the predicted texture component associated with each of the one or more second texture components based on the image characteristic associated with each of the pixel regions.

19. The non-transitory computer-readable medium of claim 15, wherein the instructions further cause the one or more processors to:
perform image filtering to the reconstructed base color image; and
determine the predicted texture component based on the filtered reconstructed base color image,
wherein the image filtering comprises at least one of low pass filtering, high pass filtering, edge detection, thresholding, or contrast enhancement.

20. The non-transitory computer-readable medium of claim 15, wherein the instructions further cause the one or more processors to:
determine a linear correlation between the one or more first texture components and each of the one or more second texture components; and
determine the predicted texture component associated with each of the one or more second texture components based on each of the linear correlation.
